(19) United States
(12) Patent Application Publication
(10) Pub. No.: US 2015/0245561 A1
(43) Pub. Date: Sep. 3, 2015

(54) Apparatus and Methods for Making Musical Instruments From Molded Gourds and Musical Instruments Made Therefrom

(71) Applicant: Fernando Dela Cruz Juan, Kihei, HI (US)

(72) Inventor: Fernando Dela Cruz Juan, Kihei, HI (US)

(21) Appl. No.: 14/195,394

(22) Filed: Mar. 3, 2014

(51) Int. Cl. A01D 91/00; B29C 44/02; G10D 1/00

(52) U.S. Cl. CPC A01D 91/00; G10D 1/005; B29C 44/02

(57) ABSTRACT

Novel apparatus and methods for making acoustic musical instruments from gourds and the musical instruments made therefrom are described. The invention teaches molds for shaping and molding immature gourds as they grow for the specific purpose of using the molded gourds, of portions of them, in the construction of the musical instrument's resonant cavity. The method of the invention produces musical instruments, particularly stringed musical instruments, from a gourd that has been molded while growing. The present invention also describes the stringed musical instrument, such as ukuleles, guitars, or violins, that result from using said described apparatus and methods.

### FIELD OF INVENTION

The present invention describes methods and apparatus for making acoustic musical instruments, including, but not limited to, ukulele, guitar, violins, and banjos, from gourds. More particularly, this invention teaches methods and molds for molding gourds to be used as sound boxes in acoustic musical instruments and the musical instruments that are made therefrom.

### BACKGROUND OF THE INVENTION

1. Prior Art

Gourds, also known as hard shell gourds [Cucurbitaceae of the genera Lagenaria and Cucurbita], have been traditionally used in many cultures in the world. Immature gourds are used as an ingredient of many cultural dishes. In addition, various uses for the mature gourds also exist. Uses for cleaned, dried, and hollowed gourds include making bird feeders, decorative hats, bowls, or for food and water storage, known as calabash or water gourds.

In the Hawaiian culture, the gourd is used, among other ways, to make percussion instruments known as the ipu-heke and the uli-uli. These instruments are often used for chanting and dancing in festivals and celebrations. Both of these musical instruments are made by cutting at least one mature gourd off at the neck and hollowing the gourd out.

The ipu-heke is a double-chambered percussion instrument made with two of these hollowed gourds attached by the necks with a hole cut in the top gourd which allows the sound to escape. The uli-uli is a traditional Hawaiian rattle, made by inserting seeds or beads into hollowed-out gourd, which is then covered with a feather cap that prohibits the seeds from escaping. While gourds are used to make these musical instruments, the shapes of the instruments are dictated by the shape of the mature gourd.

The ukulele is a small guitar-like stringed musical instrument that is associated with the Hawaiian culture. Ukuleles are commonly made of hard-woods such as koa, maple, mango, or pine. An example of a ukulele created using Hawaiian-hardwood and coconut shells is disclosed in U.S. Pat. No. 6,596,931 to Baker.

One disadvantage of manufacturing ukuleles from hard-woods is that hard-woods are difficult to shape, texture, and form. Because mature gourds do not naturally take the shape of a ukulele, much less a violin or guitar, ukuleles are not made out of gourds. Ukuleles can also be made from plastic materials, but the use of plastics is attached with a stigma of using an unnatural material made from petroleum. The sound quality of the instruments may also suffer by using plastic materials. The present invention teaches a method for making stringed musical instruments out of gourds, a renewable material which is easy to shape, texture, and form.

French Patent No. 2625361 to Beltan details methods for manufacturing stringed musical instruments from gourds. However, similar to the ipu-heke and uli-uli, Beltan illustrates that when the resonating box is made from the gourd material, the shape of the instrument is dictated by the shape of the gourd used. Hence, musical instruments made using this method have a rounded gourd shape, making the instrument difficult to hold against the user's body. The gourd shape, which varies from plant to plant, determines the quality of the sound emanating from the instrument so made, rendering it impossible to achieve instruments offering consistent tonal qualities.

Methods and apparatus for molding gourds during growth have been described for purposes other than the fabrication of musical instruments. For example, U.S. Pat. No. 2,096,507 to Czeszczicski, U.S. Pat. No. 4,187,639 to Ono, and Japan Pat. No. 1252230 to Aoyama, disclose methods and apparatuses for shaping immature gourds or fruits during growth for decorative purposes, and to facilitate fruit storage. The apparatus disclosed include two-part removable molds that rigidly enclose the growing fruit to produce decorative details on the fruit surface. Because these methods rigidly enclose the growing fruit, they do not allow overgrowth, requiring that the methods and apparatus be carefully watched as the fruit grows and fills the mold. Otherwise, compression damage to the fruit surface will result, or the fruit will rot if allowed to grow in the mold after the fruit fills the mold and begins to press the mold surface outwardly.

U.S. Pat. No. 4,827,666 to Tweddell attempts to address the overgrowth problem by teaching molds made from flexible materials that allow the mold to expand outwardly by bulging if the fruit is left in the mold after it has filled the mold cavity. Because the entire mold expands as the fruit grows, the size of resulting molded fruit will vary depending on how long the fruit is allowed to grow after it begins to press against the mold surface.

The prior art fails to offer a method of making acoustic instruments from gourds shaped in a manner conducive to sound boxes or resonating cavities, and that all for the fabrication of musical instruments that are comfortable to hold, easy to play, and produce tones that are of high quality and reproducible.

2. Objects and Advantages

The present invention teaches a method of manufacturing stringed musical instruments made from gourds that are molded during growth to a desired shape and size. Being able to mold gourds to any desired shape has several advantages. These advantages include having more flexibility to select and specify gourd shapes that, when used as a sound box in an acoustic instrument, produce better and more reproducible sound, tone, or quality, are aesthetically pleasing, and facilitate easier handling in a user's arms while the musical instrument is played.

The present invention also describes apparatus that provide a solution to the overgrowth problem when molding gourds during growth while still allowing those portions of the gourd within the mold to maintain a uniform size and shape.

Accordingly, among the several objects and advantages of the present invention are: to provide a novel method for creating musical instruments from hard shell gourds; to provide new apparatus for shaping and molding immature gourds to be suitable for use as sound boxes in acoustic musical instruments; to provide a new acoustic musical instrument made of gourd having a molded flat back; to provide a new acoustic musical instrument with a superior tone and quality; to provide a new acoustic musical instrument that is aesthetically pleasing. Still other objects and advantages will become apparent from a consideration of the ensuing description and drawings.

### SUMMARY OF INVENTION

This invention describes apparatus and methods for making acoustic musical instruments from gourds that have been molded during growth.

One aspect of the present invention is a method of molding gourds during growth in order to shape the gourds to be suitable for use as resonant cavities or sound boxes in acoustic musical instruments.

A second aspect of the present invention is apparatus, molds or forms, useful for molding gourds during growth such that the mature gourds are correctly shaped for use as resonant cavities or sound boxes in acoustic musical instruments.

A third aspect of the subject invention is acoustic musical instruments wherein the resonant cavity or sound box of the instrument is made in whole or in part from gourds that exhibit specialized shapes due to molding during growth.

### BRIEF DESCRIPTION OF THE DRAWINGS

In the drawings, closely related figures have the same number but different alphabetic suffixes.

FIG. 1 is a flow diagram of a preferred embodiment of the proposed method for making musical instruments from a gourd molded during growth.

FIG. 2 is a perspective view showing an example of a mature water gourd cut in half horizontally.

FIG. 3A is a exploded perspective view of a preferred embodiment of a three-part mold of the subject invention containing an immature gourd.

FIG. 3B is a perspective view of a preferred embodiment of the middle section of the mold in FIG. 3A containing a mature gourd prior to harvesting.

FIG. 3C is a perspective view of the molded gourd after being harvested from the mold depicted in FIGS. 3A and 3B.

FIG. 3D is a perspective view of molded gourd depicted FIG. 3C after being finished for incorporation into an acoustic musical instrument.

FIG. 4A is a cross-section side view of the three part mold with immature gourd depicted in FIG. 3A.

FIG. 4B is a cross-section side view of the three part mold with mature gourd.

FIG. 4C is a cross-section side view of the three part mold with mature gourd demonstrating overgrowth.

FIG. 4D is a side view of the mature gourd with overgrowth shown in FIG. 4C after harvesting and removal from the mold.

FIGS. 4E through 4G are perspective views of the different pieces of the molded gourd depicted in FIG. 4D after the finishing for incorporation into an acoustic musical instrument.

FIGS. 5A through 5C are cross-section side views of an alternative embodiment two-part mold with gourd illustrating the growing steps of the method of the invention.

FIG. 5D is a perspective view of the resultant finished molded gourd harvested and removed from the mold depicted in FIGS. 5B and 5C.

FIG. 5E is a perspective view of the molded gourd piece depicted in FIG. 5D with top portion removed and finished for incorporation into an acoustic instrument.

FIG. 6 shows in exploded perspective view a further embodiment of the apparatus of the present invention comprising a four-part mold.

FIG. 7 is a perspective view of the alternative embodiment two-part mold shown in FIG. 5A thorough 5C with immature gourd shown within.

FIGS. 8A through 8C are top views illustrating three embodiments of mold presses that can be used during the drying portion of the finishing step.

FIG. 9 depicts alternative shapes of the inner cavity of the mold from the top.

FIG. 10 is a perspective view of the stringed musical instrument constructed from the finished molded gourd depicted in FIG. 3D.

FIG. 11A is a cross-sectional view of a first embodiment of the stringed musical instrument of FIG. 10A taken along line 81 of FIG. 10 wherein the instrument sound box is constructed from a single piece of molded gourd.

FIG. 11B is a cross-sectional view of an alternative embodiment of the stringed musical instrument of FIG. 10A taken along line 81 of FIG. 10 wherein the instrument sound box is comprised of three pieces at least one of which is molded gourd.

FIG. 11C is a cross-sectional view of a further alternative embodiment of the stringed musical instrument of FIG. 10A taken along line 81 of FIG. 10 wherein the instrument sound box is comprised of two pieces at least one of which is molded gourd.

DRAWING REFERENCE NUMERALS

| | |
|---|---|
| 10 | Growing Step |
| 12 | Mature Gourd |
| 14 | Woody Exterior |
| 16 | Fleshy Pulp Interior |
| 18 | Gourd Plant |
| 20 | Immature Gourd |
| 22 | Mold Cavity |
| 24 | Mold |
| 24a | First Mold Part |
| 24b | Second Mold Part |
| 24c | Third Mold Part |
| 24d | Fourth Mold Part |
| 26 | First Mold Side |
| 28 | Second Mold Side |
| 30 | Excess Growth |
| 32 | First Molding Panel |
| 34 | Second Molding Panel |
| 35 | Elastic Material |
| 36 | Molded Gourd |
| 38 | Open Conduit |
| 39 | Stem |
| 40 | Harvesting Step |
| 42 | Hole |
| 44a | First Cut Line |
| 44b | Second Cut Line |
| 44c | Third Cut Line |
| 44d | Fourth Cut Line |
| 46a | First Flat Surface |
| 46b | Second Flat Surface |
| 46c | Curved Surface |
| 48a | Top Molded Gourd Piece |
| 48b | Middle Molded Gourd Piece |
| 48c | Bottom Molded Gourd Piece |
| 50 | Finishing Step |
| 52 | Mold Press |
| 54 | Desired Shape |
| 56 | Outer Mold |
| 56a | Left outer mold piece |
| 56b | Right outer mold piece |
| 58 | Outer mold cavity |
| 60 | Clamps |
| 60a | First Clamp |
| 60b | Second Clamp |
| 60c | Third Clamp |
| 60d | Fourth Clamp |
| 60e | Fifth Clamp |
| 60f | Sixth Clamp |
| 62 | Inside mold section |
| 62a | Left Inside mold section |
| 62b | Right Inside mold section |
| 64 | Desired Finish |
| 67 | Finished Molded Gourd |
| 67a | Finished Top Molded Gourd Piece |
| 67b | Finished Middle Molded Gourd Piece |
| 67c | Finished Bottom Molded Gourd Piece |
| 67c′ | Alternative Finished Bottom Molded |
| | Gourd Piece |
| 68a | First Edge |
| 68b | Second Edge |
| 69 | Spreader |
| 69a | First Spreader |
| 69b | Second Spreader |
| 69c | Third Spreader |
| 69d | Fourth Spreader |
| 70 | Constructing Step |
| 72 | Acoustic Musical Instrument |
| 74 | Resonant Cavity |
| 75 | Neck |
| 76 | Bridge |
| 78 | Strings |
| 80 | Tuning Nuts |
| 81 | Line |
| 82 | Aperture |
| 84 | Texture |
| 86 | Logo |

### DETAILED DESCRIPTION OF THE PREFERRED EMBODIMENTS

The present invention is described below referring to the accompanying drawings, wherein like numerals refer to like or corresponding elements throughout. It should be understood, however, that the drawings and detailed description relating thereto are not intended to limit the claimed subject matter to the particular form or embodiment disclosed. Rather, the intention is to cover all modifications, equivalents, and alternatives falling within the spirit and scope of the claimed subject matter.

### Method for Molding Gourds During Growth for Use

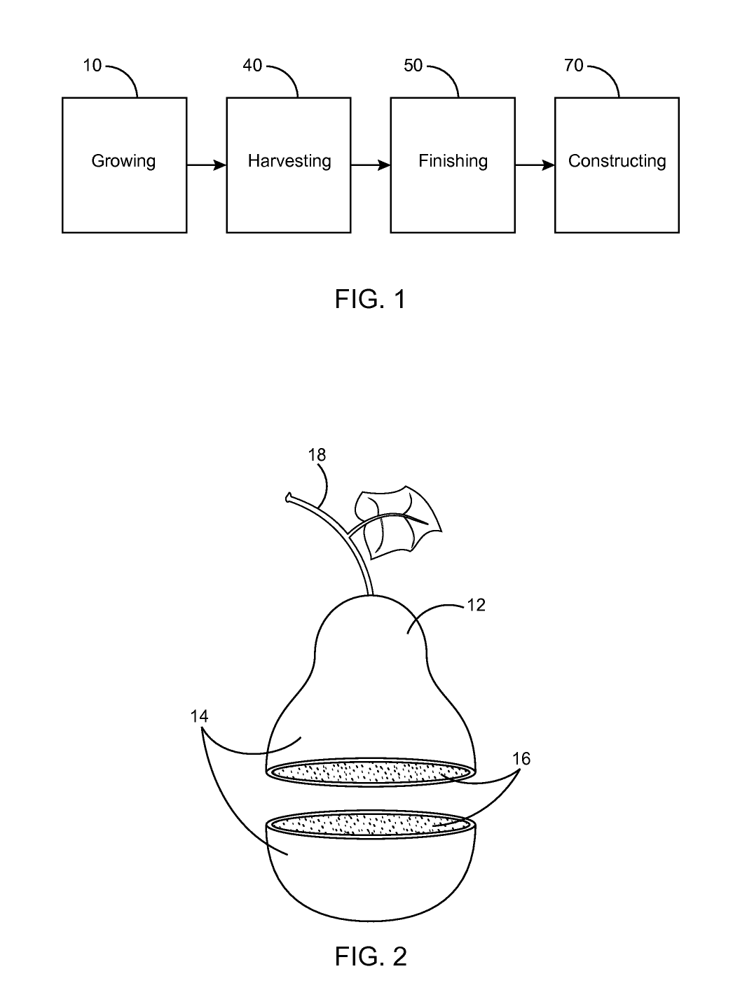

One aspect of the present invention is a method for molding gourds during growth in order to make the gourd suitable for use as a resonant cavity of an acoustic musical instrument. Referring to FIG. 1, a flow chart of the method for making musical instruments is presented in five steps: a growing step 10, a harvesting step 40, a finishing step 50, and a constructing step 70. Each of these steps is further explained below.

### Growing Step

The first step of the present invention is growing step 10. Growing step 10 begins with selecting the appropriate variety of a gourd plant 18, which will produce a mature gourd 12. In general, plants in the gourd family produce mature gourds that have a woody exterior 14 and a fleshy pulp interior 16. Mature gourd 12 can be cut open, hollowed of fleshy pulp interior 16, and dried to leave woody exterior 14 measuring from about ⅛ inch to about ½ inch in thickness. When mature, the gourds of the different gourd varieties are available in a variety of sizes and shapes. FIG. 2 illustrates an example of gourd plant 18 with mature gourd 12 that has been cut in half to show its woody exterior 14 and its fleshy pulp interior 16.

When selecting the appropriate variety of gourd plant 18, the anticipated mature gourd's size and shape must be matched with the intended use. For example, when making a tenor ukulele, a gourd variety that produces round mature gourd 12 with a volume and surface area larger than the expected body or the resonant cavity 74 of the ukulele should be selected.

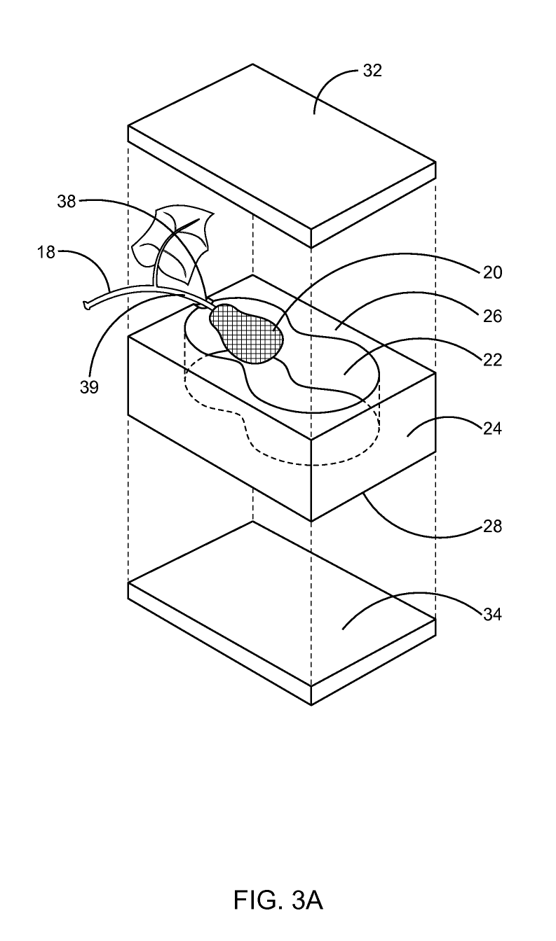

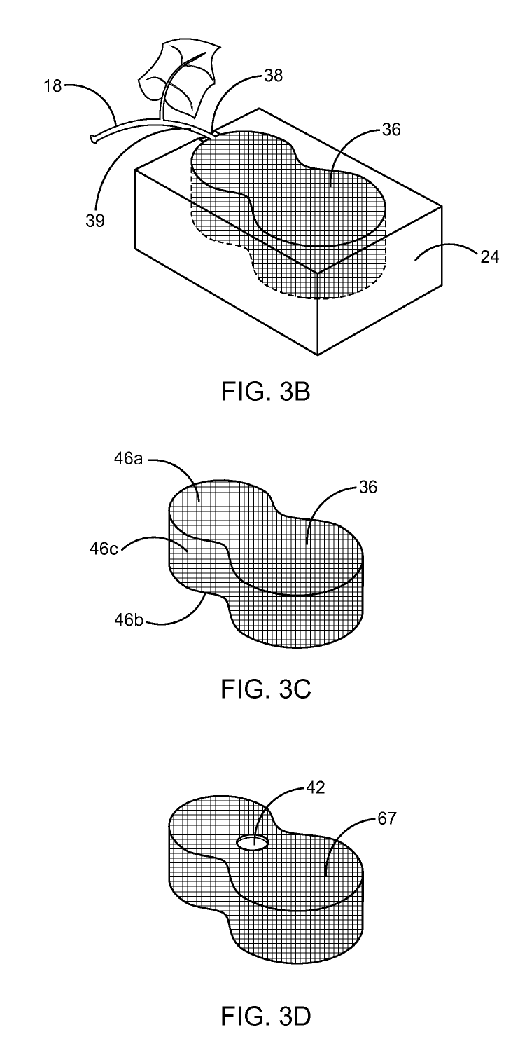

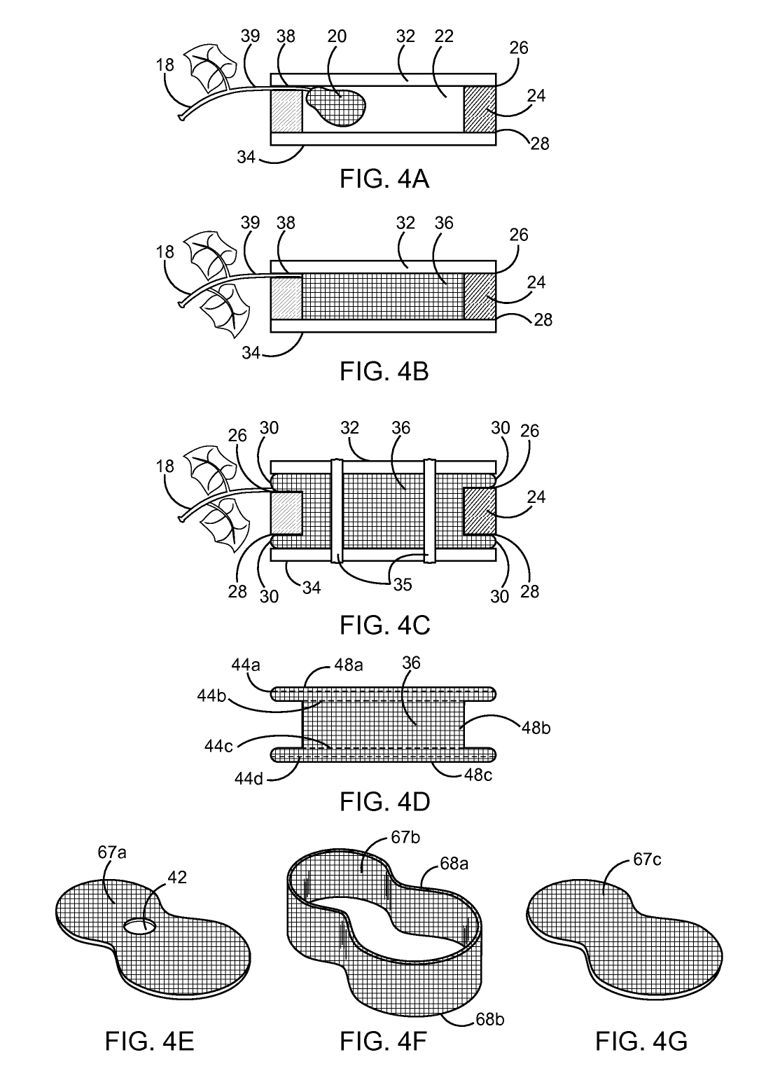

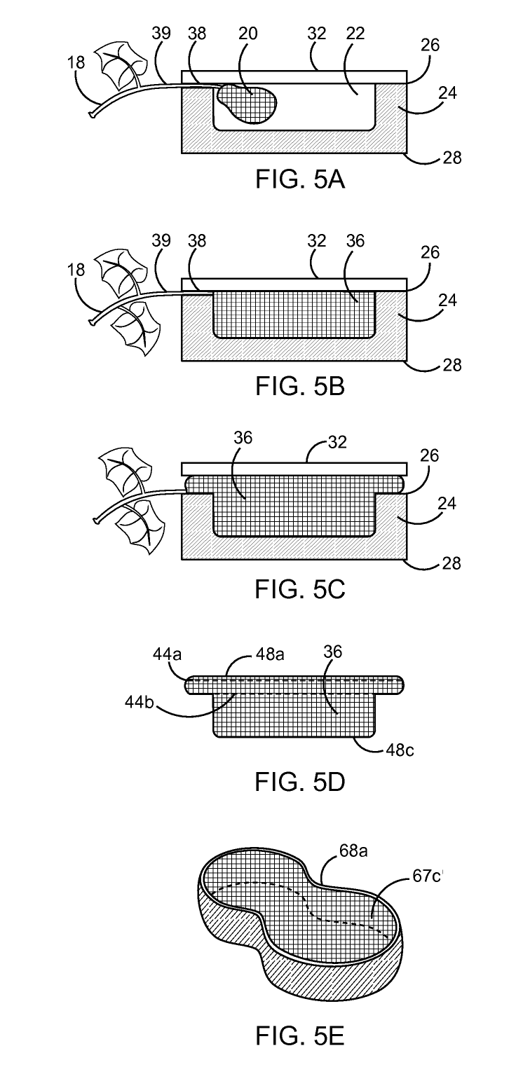

Once the variety of gourd plant 18 is selected, gourd plant 18 is grown until an immature gourd 20 is produced. FIGS. 3A through 3B and 4A through 4C illustrate the progression of growing step 10 using one preferred embodiment of a mold 24 of the present invention. FIGS. 5A through 5C illustrate the progression of growing step 10 using another preferred embodiment of mold 24 of the present invention.

As illustrated in FIGS. 3A, 4A, 5A, and 7, gourd plant 18 is grown until immature gourd 20 is produced. Prior to reaching full maturity, immature gourd 20 is inserted into a mold cavity 22 of mold 24. Immature gourd 20 should be inserted when it is smaller than mold cavity 22 so that immature gourd 20 is not damaged during its introduction into mold cavity 22.

After immature gourd 20 is inserted into mold cavity 22, immature gourd 20 is allowed to continue to grow in mold cavity 22. As immature gourd 20 grows, immature gourd 20 fills and conforms to the shape of mold cavity 22. FIGS. 3B, 4B, and 5B depict a molded gourd 36 of gourd plant 18 that has grown to fill and conform to the shape of mold cavity 22.

After immature gourd 20 fills and conforms to the shape of mold cavity 22, molded gourd 36 can be harvested immediately using harvesting step 40. Alternatively, molded gourd 36 can remain in mold 24 and be allowed to continue to grow on gourd plant 18 before harvesting. As shown in FIGS. 4C and 5C, if molded gourd 36 is left in mold 24 and allowed to continue to grow on gourd plant 18 after it fills and conforms to mold cavity 22, an excess growth 30 of molded gourd 36 will push outwardly from mold 24. Excess growth 30 of molded gourd 36 is shown in FIGS. 4C and 5C.

At any time after immature gourd 20 is placed in mold 24 and prior to harvesting step 40, one or more optional molding panels can be arranged to cover mold cavity 22 such that the molding panels will further mold and conform the portions of immature gourd 20 that comes into contact with the molding panel. A first molding panel 32 and a second molding panel 34 are shown in FIGS. 3A, 4A, 4B, 4C, and 6. FIGS. 5A thorough 5C and 7 illustrate embodiments where only first molding panel 32 is present.

### Harvesting Step

During harvesting step 40, molded gourd 36 is cut from gourd plant 18, removed from mold 24. Next, molded gourd 36, or a section thereof, is hollowed of its fleshy pulp interior 16. In harvesting step 40, a hole 42 can be cut in molded gourd 36 and fleshy pulp interior 16 is removed from the inside of molded gourd 36 through hole 42. Alternatively, molded gourd 36 can be cut into one or more pieces and fleshy pulp interior 16 is removed from each of the pieces.

FIGS. 3C, 4D and 5D are examples of three molded gourds 36 that have been harvested by cutting from gourd plant 18 and removing from mold 24.

Referring to FIG. 3C, molded gourd 36 has three surfaces—a first flat surface 46a and a second flat surface 46b, and a curved surface 46c. In this embodiment, during the harvesting step, hole 42 would be cut on first flat surface 46a and fleshy pulp interior 16 is removed from molded gourd 36 through hole 42 until only woody exterior 14 remains.

Referring to FIG. 4D, four cuts are made into molded gourd 36 and three of the pieces are isolated—a top molded gourd piece 48a, a middle molded gourd piece 48b, and a bottom molded gourd piece 48c. Top molded gourd piece 48a is formed by cutting molded gourd 36 along a first cut line 44a, middle molded gourd piece 48b is formed by cutting molded gourd 36 along a second cut line 44b and a third cut line 44c, and bottom molded gourd piece 48c is formed by cutting molded gourd 36 along a fourth cut line 44d. Any portion of molded gourd 36 between first and second cut lines 44a and 44b is discarded, and any portion of molded gourd 36 between third and fourth cut lines 44c and 44d is discarded. Fleshy pulp interior 16 attached to top molded gourd piece 48a, middle molded gourd piece 48b, or bottom molded gourd piece 48c is removed until only woody exterior 14 remains.

Referring to FIG. 5D, in this alternate embodiment, two sections of molded gourd 36 are isolated—top molded gourd piece 48a and bottom molded gourd piece 48c. Top molded gourd piece 48a is formed by cutting molded gourd 36 along first cut line 44a, and a bottom molded gourd piece 48c is formed by cutting molded gourd 36 along second cut line 44b. Any portion of the molded gourd 36 between first and second cut lines 44a and 44b is discarded. Fleshy pulp interior 16 that is attached to the top molded gourd piece 48a and bottom molded gourd piece 48c is removed until only woody exterior 14 remains.

### Finishing Step

During Finishing step 50, molded gourd 36 or one or more of the molded gourd pieces is further dried and shaped.

During the drying portion of finishing step 50, heat can be applied to molded gourd 36 or the molded gourd pieces to further remove moisture and water content from the gourd material. While drying, molded gourd pieces can be placed into a mold press 52 so that the harvested molded gourd or the harvested molded gourd pieces maintain a desired shape 54. The harvested molded gourd or molded gourd pieces can be removed from mold press 52 once fully dried.

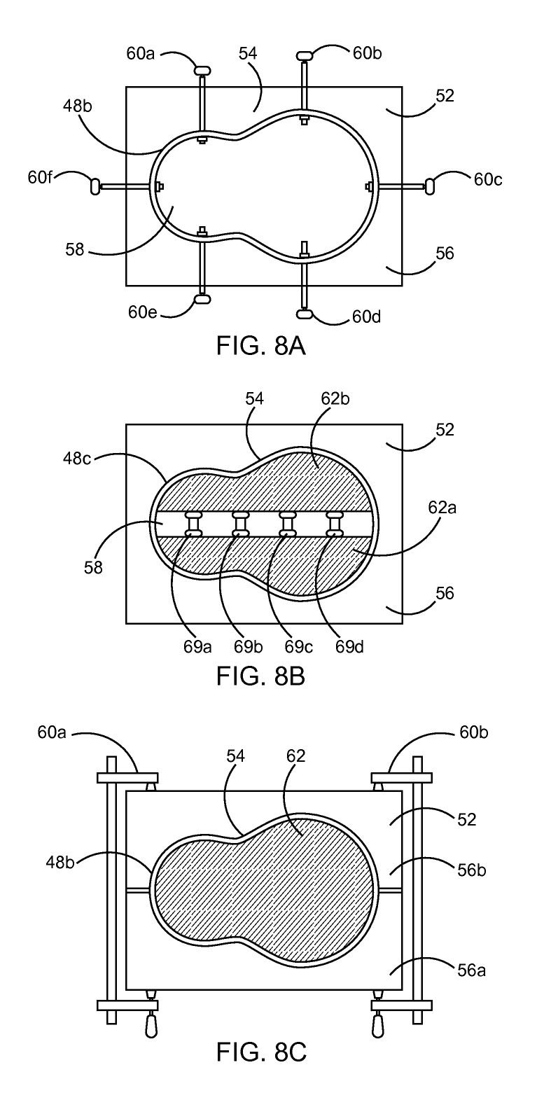

FIGS. 8A through 8C illustrate three examples of mold presses that can be used to dry middle molded gourd piece 48b during the drying portion of finishing step 50. FIG. 8A illustrates mold press 52, which is configured to shape the outside wall of middle molded gourd piece 48b, and comprises an outer mold 56 containing an outer mold cavity 58. Outer mold cavity 58 is configured to have desired shape 54 such that the outside wall of the middle molded gourd piece 48b engages the surface of outer mold cavity 58. Middle molded gourd piece 48b is secured to outer mold 56 using multiple clamps. In mold press 52 illustrated in FIG. 8A, middle molded gourd piece 48b is fastened to outer mold cavity 58 using six clamps 66a, 66b, 66c, 66d, 66e, and 66f.

In FIG. 8B, mold press 52 comprises outer mold 56 containing outer mold cavity 58, a left interior mold section 62a, a right interior mold section 62b, and four spacers labeled 69a, 69b, 69c, and 69d. Left interior mold piece section 62a is configured to shape the left inside wall of middle molded gourd piece 48b, the right interior mold piece section 62b is configured to shape the right inside wall of middle molded gourd piece 48b, and outer mold cavity 58 is configured shape the outside wall of the middle molded gourd piece 48b with desired shape 54. Middle molded gourd piece 48b is fitted inside outer mold cavity 58 and left and right interior mold sections 62a and 62b are placed inside middle molded gourd piece 48b. Expandable bolts 69a, 69b, 69c, and 69d are placed between left and right interior mold sections 62a and 62b. Left and right interior mold sections 62a and 62b are configured such that when expandable bolts 69a, 69b, 69c, and 69d, are expanded, middle molded gourd piece 48b is sandwiched between outer mold cavity 58 and left and right interior mold sections 62a and 62b as illustrated in FIG. 8B.

Referring FIG. 8C, mold press 52 comprises a left outer mold section 56a, a right outer mold section 56b, an inside mold section 62, and two clamps, 60a and 60b. Inside mold section 62 is configured to shape the inside wall of middle molded gourd piece 48b to a desired shape 54, left outer mold section 56a is configured to shape the left outside wall of middle molded gourd piece 48b, and right outer mold section 56b is configured to shape the right outside wall of middle molded gourd piece 48b. Inside mold section 62 is positioned inside middle molded gourd piece 48b and left and right outer mold sections 56a and 56b are positioned on the outside of middle molded gourd piece 48b, such that middle molded gourd piece 48b is sandwiched between the inside mold section 62 and the left and right outer mold sections 56a and 56b. Left and right outer mold sections 56a and 56b, middle molded gourd piece 48b, and inside mold section 62 are held in place by first and second clamps 60a and 60b as illustrated in FIG. 8C.

During the shaping portion of the finishing step 50, molded gourd 36 or the molded gourd pieces are further shaped. Molded gourd 36 or the molded gourd pieces can be scraped, sanded, buffed, and polished. Paint, varnish, stain, clear coat, or any desired finish 64 may be applied to the surface of any molded gourd 36 or molded gourd pieces.

FIG. 3D illustrates a finished molded gourd 67 with hole 42 that has undergone finishing step 50.

Referring to the embodiment shown in FIG. 4D, top and bottom molded gourd pieces 48a and 48c would be cut, shaped and sanded to be attached to the periphery of middle molded gourd piece 48b. Hole 42 would be cut in the upper center of top molded gourd piece 48a. For this embodiment, an example of the finished top molded gourd piece 67a with hole 42 is illustrated in FIG. 4E, an example of the finished middle molded gourd piece 67b is illustrated in FIG. 4F, and an example of the finished bottom molded gourd piece 67c is illustrated in FIG. 4G. Finished middle molded gourd piece 67b is defined by a first edge 68a and a second edge 68b, which is opposite first edge 68a.

Referring to the embodiment of a molded mature gourd shown in FIG. 5D, top molded gourd piece 48a would be further cut, shaped, and sanded to be attached to the periphery of bottom molded piece 48c. Hole 42 would also be cut in the upper center of top molded gourd piece 48a. For this embodiment, an example of finished top molded gourd piece 67a with hole 42 is illustrated in FIG. 4E and an example of the alternative finished bottom molded gourd piece 67c′ is illustrated in FIG. 5E. Alternative finished bottom molded gourd piece 67c′ has a first edge 68a.

At any time during finishing step 50 prior to the application of desired finish 64, water may be reapplied to molded gourd 36 or to one or more of the molded gourd pieces to make them more pliable and easier to work with. The wet hollowed molded gourd 36 or molded gourd pieces can then be dried using the drying process described above.

### Constructing Step

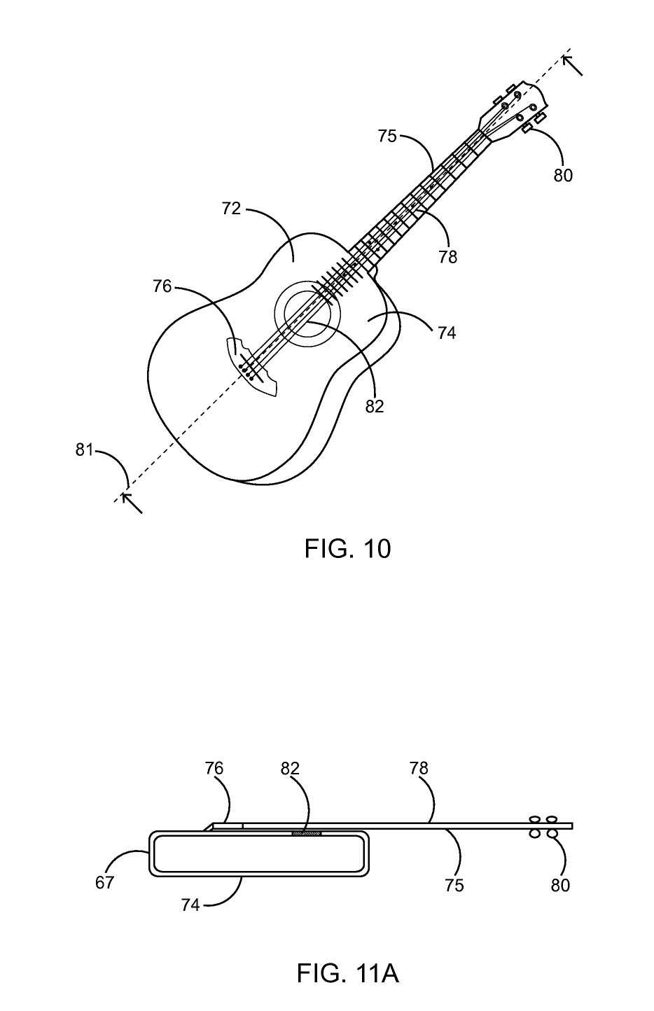

In constructing step 70, an acoustic musical instrument 72, examples of which are illustrated in FIGS. 10 and 12, is assembled. Referring to FIG. 10, acoustic musical instrument 72 comprising parts traditional to the construction of an acoustic musical instrument 72, such as a neck 75, a bridge 76, strings 78, tuning nuts 80, an aperture 82 and resonant cavity 74, which is made using finished molded gourd 67 or the finished molded gourd pieces. Acoustic musical instrument 72 can be further sanded, painted, varnished, or stained as desired.

The present invention anticipates that resonant cavity 74 can be made using finished molded gourd 67 with hole 42, illustrated in FIG. 3D, or from at least one or more of the following pieces—finished top molded gourd piece 67a, finished middle molded gourd piece 67b, finished bottom molded gourd piece 67c, or alternative finished bottom molded gourd piece 67c′. Those portions of resonant cavity 74 that are not made from finished molded gourd 67, finished top molded gourd piece 67a, finished middle molded gourd piece 67b, finished bottom molded gourd piece 67c, or alternative finished bottom molded gourd piece 67c′ can be made of other materials such as hard woods, such as koa, milo wood, or monkeypod.

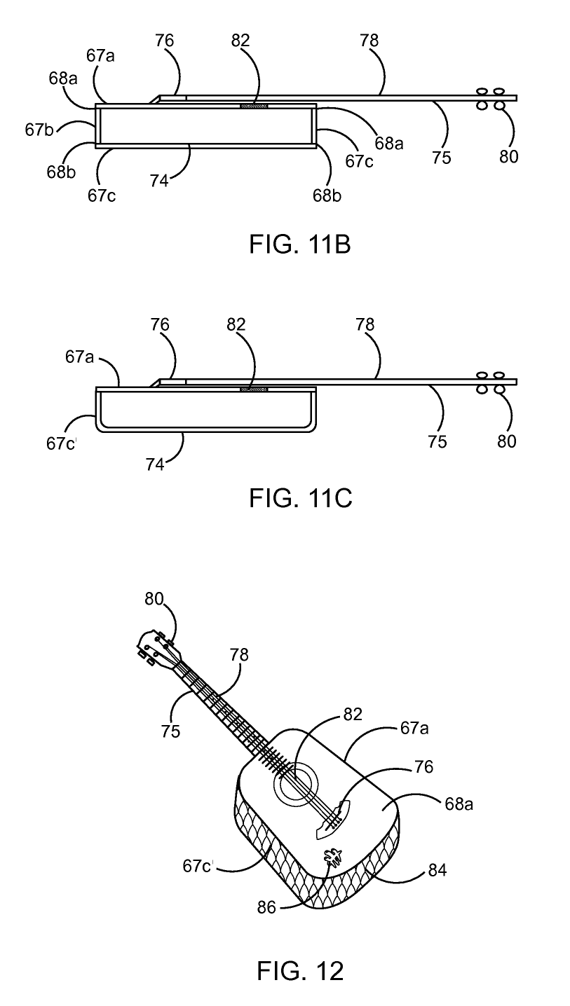

FIG. 11A is a cross sectional view of one embodiment of acoustic musical instrument 72 of the present invention taken along line 81 of FIG. 10. In this embodiment, finished molded gourd 67 with hole 42, illustrated in FIG. 3D, is used as resonant cavity 74.

FIG. 11B is a cross sectional view of an alternative embodiment of acoustic instrument 72 of the present invention taken along line 81 of FIG. 10. According to this embodiment, resonant cavity 74 of acoustic musical instrument 72 is assembled using finished top molded gourd piece 67a illustrated in FIG. 4E, finished middle molded gourd piece 67b with first edge 68a and second edge 68b illustrated in FIG. 4F, and finished bottom molded gourd piece 67c illustrated in FIG. 4G. The periphery of finished top molded gourd piece 67a is attached to first edge 68a of finished middle molded gourd piece 67b and the periphery of finished bottom molded gourd piece 67c is connected to second edge 68b of finished middle molded gourd piece 67b. Hole 42 becomes aperture 82 for the acoustic musical instrument 72.

FIG. 11C is a cross sectional view of a third preferred embodiment of acoustic instrument 72 of the present invention taken along line 81 of FIG. 10. In this embodiment, resonant cavity 74 of acoustic musical instrument 72 is assembled using finished top molded gourd piece 67a with hole 42 illustrated in FIG. 4E and alternative finished bottom molded gourd piece 67c′ illustrated in FIG. 5E. Finished top molded gourd piece 67a and alternative finished bottom molded gourd piece 67c′ are attached at their periphery edges. Hole 42 becomes aperture 86 for the acoustic musical instrument 72.

### Molds or Forms Useful for Molding Gourds During Growth

A further aspect of the present invention are apparatus for molding gourds during growth to render the gourds suitable for use as resonant cavities of an acoustic musical instrument, to with molds or forms. Referring to FIG. 3A, the most basic embodiment of the mold useful for molding gourds during growth of the present invention, comprises mold 24 which houses mold cavity 22. Mold 24 is made with a rigid, inflexible material that can withstand the outward force of growing immature gourd 20. Some examples of possible mold materials are concrete, steel, plastic, wood, clay, or ceramic.

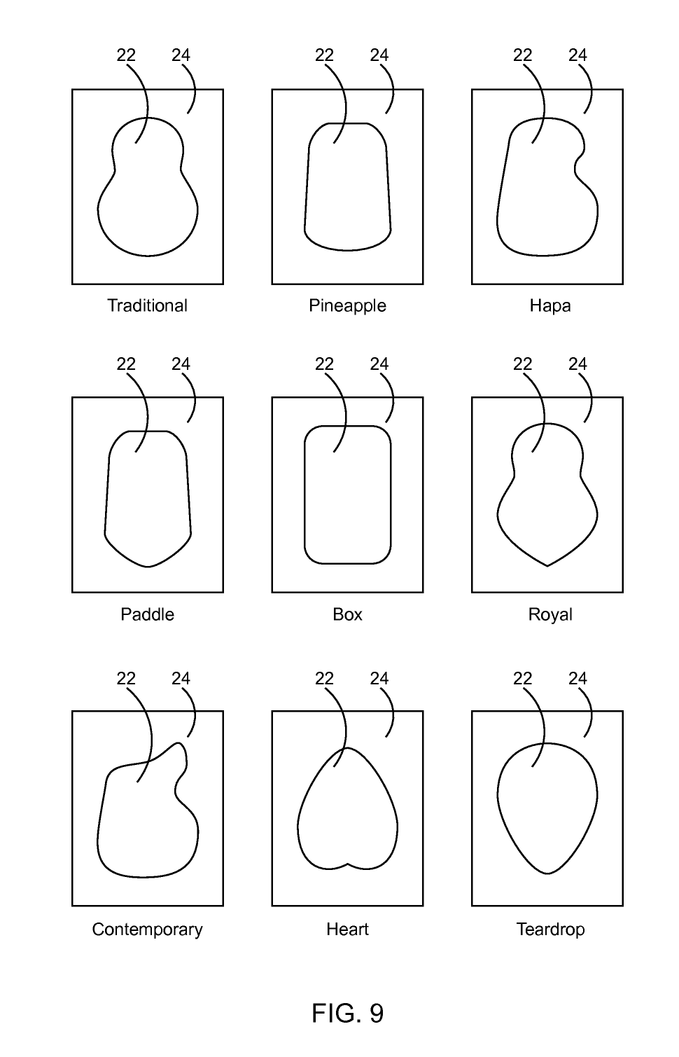

Mold cavity 22 can demonstrate various shapes and sizes including, but not limited to the shapes of a peanut, rectangle, heart, tear drop, or even pineapple. FIG. 9 illustrates some of the alternative shape configurations for mold cavity 22.

In the preferred embodiment illustrated in FIGS. 3A through 3B and 4A through 4C, mold cavity 22 extends through mold 24 from a first mold side 26 to a second mold side 28, on the opposite side of mold 24. In the preferred embodiment illustrated in FIGS. 5A through 5C, mold cavity 22 is centered on first mold side 26 but does not extend through mold 24 to second mold side 28.

Optional outside molding panels can be placed adjacent to the first and second mold sides 26 and 28. FIGS. 3A, 3B, 4A through 4C, and 6 illustrate embodiments of the mold 24 with outside molding panels. First molding panel 32 is placed adjacent to first mold side 26 and second molding panel 34 is placed adjacent to second mold side 28. FIGS. 5A through 5C and 7 illustrate embodiments of mold 24 wherein mold 24 comprises continuous sides and a bottom, requiring only first molding panel 32. According to this embodiment, first molding panel 32 is placed adjacent to first mold side 26.

Referring again to FIGS. 4A through 4C, immature gourd 20 is placed in mold cavity 22 and allowed to grow. As immature gourd 20 grows, immature gourd 20 fills mold cavity 22 and the excess growth pushes out of mold 24. The outward force of the excess growth pushes first and second molding panels 32 and 34 away from mold 24, such that that excess growth 30 grows between mold 24 and first molding panel 32 and between mold 24 and second molding panel 34. The surface of excess growth 30 that comes into contact with the first and second molding panels 32 and 34 are further molded to conform to the surface of first and second molding panels 32 and 34.

As illustrated in FIG. 4C, immature gourd 20 has grown to fully fill and conform to mold cavity 22 and excess growth 30 has grown between mold 24 and first molding panel 32 and between mold 24 and second molding panel 34. The surface of excess growth 30 that has come in contact with first and second molding panels 32 and 34 has further conformed to the surface of these panels, such that molded gourd 36 has two flat sides, as illustrated in FIG. 4D.

As seen in FIG. 5C, immature gourd 20 has filled mold cavity 22 and excess growth 30 of immature gourd 20 has pushed first molding panel 32 away from mold 24. Excess growth 30 has grown between mold 24 and first molding panel 32. The surface of excess growth 30 that has come in contact with first molding panel 32 has further conformed to the surface of first molding panel 32 such that molded gourd 36 has one flat side, as illustrated in FIG. 5D.

First molding panel 32 and/or second molding panel 34 can also be fastened to mold 24 with an elastic material 35. However, first and/or second molding panels 32 and 34 should not be tied so tightly to mold 24 that top molding panel 32 is restricted from moving away from mold 24. FIG. 4C illustrates elastic material 35 being used to fasten top molding panel 32 and bottom molding panel 34 to mold 24.

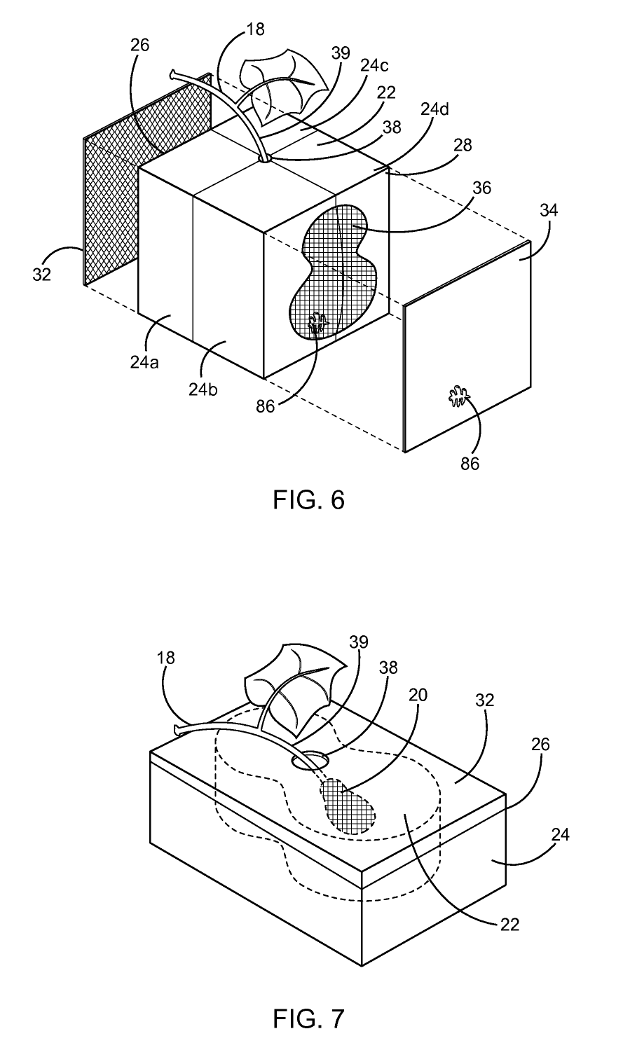

To make removal of molded gourd 36 from mold 24 easier, mold 24 may consist of multiple parts that when combined create the desired mold 24 and mold cavity 22. FIG. 6 depicts an example of mold 24 comprising four mold parts—24a, 24b, 24c, and 24d.

An open conduit 38 to accommodate stem 39 of gourd 36 can also be added to mold 24 as seen in FIGS. 3A, 3B and 6, or to the first molding plate as seen in FIG. 7.

The surface of mold cavity 22, first molding panel 32, or second molding panel 34 can be decorated with a desired pattern or texture 84 or with a desired graphic image or logo 86. For example, in the embodiment illustrated in FIG. 6, the inside surface of first molding panel 32 is engraved to demonstrate a texture 84 with hatched pattern and the inside surface of second molding panel 34 is engraved or embossed to demonstrate logo 86 in the shape of a fern leaf. FIG. 6 also shows the image of logo 86 imprinted onto immature gourd 20. FIG. 11B also shows the mirror image of logo 86 onto finished molded gourd 67.

### The Acoustic Musical Instrument

Another aspect of the present invention is acoustic musical instruments 72, in which some or all portions of the resonant cavity of acoustic musical instrument 72 is made from molded gourd 36. In each embodiment, traditional parts of an acoustic musical instrument, including neck 75, aperture 82, strings 78, bridge 76, and tuning nuts 80 are added to complete acoustic musical instrument 72.

Any portions of resonant cavity 74 that are made from molded gourd 36 can be molded to have a specific texture 84 or to have a graphic image or logo 86.

FIGS. 10 through 12 depict three specific embodiments of acoustic musical instrument 72 of the present invention.

### EXAMPLE 1

One preferred embodiment of acoustic musical instrument 72 of the present invention is a ukulele illustrated in FIGS. 10 (perspective view) and 11A (cross sectional view). As illustrated in FIG. 11, which is a cross sectional view of a first embodiment of acoustic musical instrument 72 of FIG. 10 taken along line 81 of FIG. 10, resonant cavity 74 of acoustic musical instrument 72 is made from a single molded gourd 36 that encloses a hollow resonant cavity 74.

Molded gourd 36 can be formed to have various shapes and sizes using the methods for molding gourds described above. In the case of FIG. 10A, molded gourd 36 was shaped to have double-lobed, peanut-shaped planar top and bottom. Aperture 82 is centrally located on the top surface of molded gourd 36.

### EXAMPLE 2

A cross sectional view of an alternative embodiment of acoustic musical instrument 72 of FIG. 10 taken along line 81 of FIG. 10 is illustrated in FIG. 11B. In this embodiment, resonant cavity 74 of acoustic musical instrument 72 is assembled using finished top molded gourd piece 67a illustrated in FIG. 4E, finished middle molded gourd piece 67b with first edge 68a and second edge 68b illustrated in FIG. 4F, and finished bottom molded gourd piece 67c illustrated in FIG. 4G. The periphery of finished top molded gourd piece 67a is connected to first edge 68a of finished middle molded gourd piece 67b and the periphery of finished bottom molded gourd piece 67c is connected to second edge 68b of finished middle molded gourd piece 67b. Hole 42 becomes aperture 82 for acoustic musical instrument 72.

### EXAMPLE 3

FIG. 11C illustrates the cross section of 10 along line 81 of FIG. 10 of a third embodiment of acoustic musical instrument 72. In this embodiment, resonant cavity 74 of acoustic musical instrument 72 is assembled using finished top molded gourd piece 67a with hole 42 illustrated in FIG. 4E and alternative finished bottom molded gourd piece 67c′ illustrated in FIG. 5E. The periphery of finished top molded gourd piece 67a is attached to first edge 68a of alternative finished bottom molded gourd piece 67c′. Hole 42 becomes aperture 86 for acoustic musical instrument 72.

### EXAMPLE 4

An additional embodiment of acoustic musical instrument 72 of the present invention is a pineapple shaped ukulele illustrated in FIG. 12. In this embodiment, resonant cavity 74 of acoustic musical instrument 72 is assembled using finished top molded gourd piece 67a with hole 42 illustrated in FIG. 4E and alternative finished bottom molded gourd piece 67c′ illustrated in FIG. 5E. The periphery of finished top molded gourd piece 67a is attached to first edge 68a of alternative finished bottom molded gourd piece 67c′. Hole 42 becomes aperture 82 for acoustic musical instrument 72. In this embodiment, finished top molded gourd piece 67a has been molded to have a pineapple-shaped planar surface and logo 86. The alternative finished bottom molded gourd piece 67c′ was molded to have a rounded shape with texture 84 of a pineapple.

Although the examples and embodiments described above take the form of ukuleles, the same examples and embodiments may be given for guitars and other acoustic musical instruments without departing from the scope of the subject invention.

### CONCLUSION, RAMIFICATIONS, AND SCOPE

As described above, superior acoustic musical instruments can be constructed from hard shelled gourds that have been shaped during growth to exhibit shapes that are pleasing to the eye, comfortable to hold, easy to play, and that produce reproducible sounds having desired tonal qualities and volumes. The specialized shapes are produced with consistency during growth by following the specific steps and using specialized molds detailed above and in the accompanying drawings. While the above description and accompanying drawings contain much specificity, these should not be construed as limitations on the scope of the invention, but rather, as exemplifications of the presently preferred embodiments thereof. Many other ramifications and variations are possible within the teachings of the invention. For example, while the apparatus and methods have been described primarily in terms of stringed acoustic instruments, percussive acoustic instruments may equally be constructed using the methods and apparatus taught herein.

Thus, the scope of the invention should be determined by the appended claims and their legal equivalents, and not by the specific examples and alternative embodiments given

1. A method for making acoustic musical instruments from gourds, comprising the steps of:
a. growing a gourd within a mold until said gourd matures and conforms to the shape of said mold;
b. harvesting the molded gourd;
c. finishing said molded gourd; and
d. constructing an acoustic musical instrument such that said molded gourd forms at least a portion of the resonant cavity of said instrument.

2. The method of claim 1, wherein said gourd following harvest has a stem and hard shell filled with fleshy pulp, and wherein the harvesting step further comprises:
a. removing molded gourd from said mold;
b. separating said molded gourd from its stem; and
c. removing the inner fleshly pulp from within said gourd shell.

3. The method of claim 1, wherein the finishing step further comprises one or more of the following additional steps: drying, shaping, cutting, sanding, and coating said molded gourd.

4. The method of claim 3 wherein shaping of the harvested gourd is accomplished by means of soaking, forms and clamps.

5. A form for shaping gourds during growth for use as resonant cavities in acoustic musical instruments, wherein said form defines a cavity having a shape reflecting the desired shape of said musical instrument resonant cavity.

6. The form of claim 5 wherein said growing gourd comprises a stem with fruit and said form includes a conduit to accommodate the gourd stem.

7. The form of claim 5 wherein the form comprises left and right portions which separate for easy removal of said gourd when mature.

8. The form of claim 5 wherein said mold further comprises a base with removable top which together define and fully enclose said cavity and wherein the mature gourd is shaped by said cavity as enclosed.

9. The form of claim 8 wherein said removable top is affixed to said base by elastic means such that, as the gourd grows within said form, the elastic means allows the gourd to push said top away from said base during growth thereby preserving the desired gourd shape while permitting additional growth.

10. The form of claim 5 wherein said mold further comprises a body open at the top and bottom, a removable top and a removable bottom, the body, top and bottom together defining and fully enclosing said cavity, and elastic means that affix said removable top and bottom to said body and allow said gourd to press outward from said body during growth thereby preserving the desired gourd shape while permitting additional growth.

11. The form of claim 5 wherein said form is comprised of a plurality of layered parts facilitating the easy removal of said gourd when mature.

12. The form of claim 5 wherein the inside surface of said form is engraved with decorative motifs that imprint a mirror image onto the outside surface of said gourd.

13. An acoustic musical instrument with resonant cavity wherein said resonant cavity is constructed at least in part from a gourd molded during growth.

14. The musical instrument of claim 13 wherein said gourd has been molded to demonstrate rounded sides, a flat top and a flat bottom.

15. The musical instrument of claim 13 wherein said gourd has been molded to demonstrate a rounded bottom, rounded sides and a flat top.

16. The musical instrument of claim 13 wherein said resonant cavity is constructed from said molded gourd together with hardwood.

17. The musical instrument of claim 13 wherein said resonant cavity is form from a single piece of molded gourd.

18. The musical instrument of claim 13 wherein said resonant cavity is formed from a plurality of pieces of molded gourd cemented together.

19. The musical instrument of claim 13 wherein said resonant cavity is comprised of a body constructed from a single piece of molded gourd and a top and bottom constructed of hardwood.

20. The musical instrument of claim 13 wherein said gourd is molded by:
a. growing a gourd within a mold until said gourd matures and conforms to the shape of said mold;
b. harvesting the molded gourd; and
c. finishing said molded gourd.
